(19) United States
(12) Patent Application Publication
(10) Pub. No.: US 2019/0018359 A1
(43) Pub. Date: Jan. 17, 2019

(54) IMAGE FORMING APPARATUS

(71) Applicant: CANON KABUSHIKI KAISHA, Tokyo (JP)

(72) Inventors: Yuki Sugiyama, Suntou-gun (JP); Masato Suzuki, Mishima-shi (JP); Naoki Yoshikawa, Kawasaki-shi (JP)

(21) Appl. No.: 16/027,142

(22) Filed: Jul. 3, 2018

(30) Foreign Application Priority Data
Jul. 13, 2017 (JP) 2017-136749

(51) Int. Cl. G03G 15/00

(52) U.S. Cl. CPC G03G 15/6564; G03G 15/6529

(57) ABSTRACT

An image forming apparatus includes a conveying unit, transfer unit, a loop detecting unit, a driving source, a control unit, and a measuring unit. The transfer unit transfers an image formed on an image bearing member to the printing material conveyed by the conveying unit driven by the driving source. The loop detecting unit detects an amount of a loop formed in the printing material between the conveying and transfer units. The control unit changes a rotational speed of the driving source based on the detection result. The measuring unit measures a rotation amount of the driving source while a first printing material is conveyed by both of the conveying and transfer units. The control unit controls the rotational speed of the driving source based on the measured rotation amount so that a leading end of a second printing material reaches the transfer unit per the image bearing member image.

### BACKGROUND OF THE INVENTION

### Field of the Invention

The present disclosure relates to image forming apparatuses, such as copiers and printers.

### Description of the Related Art

For image forming apparatuses such as copiers and printers, loop control for detecting the degree of a loop formed in a sheet between two conveying units and changing the speed of the sheet conveyed by the conveying units according to the detected degree (loop amount).

Japanese Patent Laid-Open No. 1-176746 discloses control of the degree of a loop between a registration roller pair for synchronously conveying a sheet and an image forming unit. The image forming apparatus disclosed in Japanese Patent Laid-Open No. 1-176746 increases the speed at which the sheet is conveyed by the registration roller pair upon determining that the degree of a loop formed in the sheet between the registration roller pair and the image forming unit is low. Upon determining that the degree of the loop formed in the sheet is high, the image forming apparatus decreases the sheet conveying speed of the registration roller pair.

Japanese Patent No. 4626525 discloses control of a loop between a transfer unit that transfers a toner image formed on an intermediate transfer belt to a sheet and a fixing unit that fixes the transferred toner image to the sheet. The outside diameter of the fixing unit (fixing roller) changes with time as the total number of printed sheets increases. When the outside diameter of the fixing unit changes, the actual speed at which the sheet is conveyed by the fixing unit changes even if a motor that drives the fixing unit is rotated at the same rotational speed.

To respond to the change in the outside diameter of the fixing unit, the image forming apparatus disclosed in Japanese Patent No. 4626525 measures the cumulative time a loop sensor outputs ON signals in a period during which one sheet of paper is conveyed by both of the transfer unit and the fixing unit. In Japanese Patent No. 4626525, the loop sensor outputs an ON signal when the degree of a loop formed in the sheet between the transfer unit and the fixing unit is high. Therefore, when the total time during which ON signals are output is long, the central processing unit (CPU) determines that the actual speed at which the sheet is conveyed by the fixing unit is low and increases the rotational speed of the motor that drives the fixing unit.

Also the outside diameter of the registration roller pair described in Japanese Patent Laid-Open No. 1-176746 changes with time as the total number of printed sheets increases. In other words, the registration roller pair is worn out due to long use, so that the outside diameter decreases. The change in the actual sheet conveying speed of the registration roller pair makes it difficult to keep synchronization with the image formed on the image bearing member, causing misregistration of an image formed on the sheet.

### SUMMARY OF THE INVENTION

The present disclosure provides an image forming apparatus that controls the speed at which a conveying unit conveys a printing material toward a transfer unit to reduce misregistration of an image transferred to the printing material.

According to an aspect of the present invention, an image forming apparatus includes a conveying unit configured to convey a printing material, a transfer unit configured to transfer an image formed on an image bearing member to the printing material conveyed by the conveying unit, a loop detecting unit configured to detect an amount of a loop formed in the printing material between the conveying unit and the transfer unit, a driving source configured to drive the conveying unit, a control unit configured to change a rotational speed of the driving source based on the detection result of the loop detecting unit, and a measuring unit configured to measure a rotation amount of the driving source during a period in which a first printing material is conveyed by both of the conveying unit and the transfer unit, wherein the control unit controls the rotational speed of the driving source based on the rotation amount of the driving source measured by the measuring unit so that a leading end of a second printing material reaches the transfer unit in accordance with the image formed on the image bearing member.

Further features of the present invention will become apparent from the following description of embodiments with reference to the attached drawings.

### BRIEF DESCRIPTION OF THE DRAWINGS

FIG. 1 is a schematic diagram of an image forming apparatus according to an embodiment of the present disclosure.

FIG. 2 is a control block diagram of the image forming apparatus.

FIGS. 3A and 3B are schematic diagrams illustrating a state in which transfer loop control is executed.

FIG. 4 is a flowchart for transfer loop control according to a first embodiment of the present disclosure.

FIG. 5 is a flowchart for image registration control according to the first embodiment.

FIGS. 6A and 6B illustrate a flowchart for an expansion or contraction detecting process according to the first embodiment.

FIG. 7 is a flowchart for a life/replacement detecting process according to a second embodiment of the present disclosure.

### DESCRIPTION OF THE EMBODIMENTS

### First Embodiment

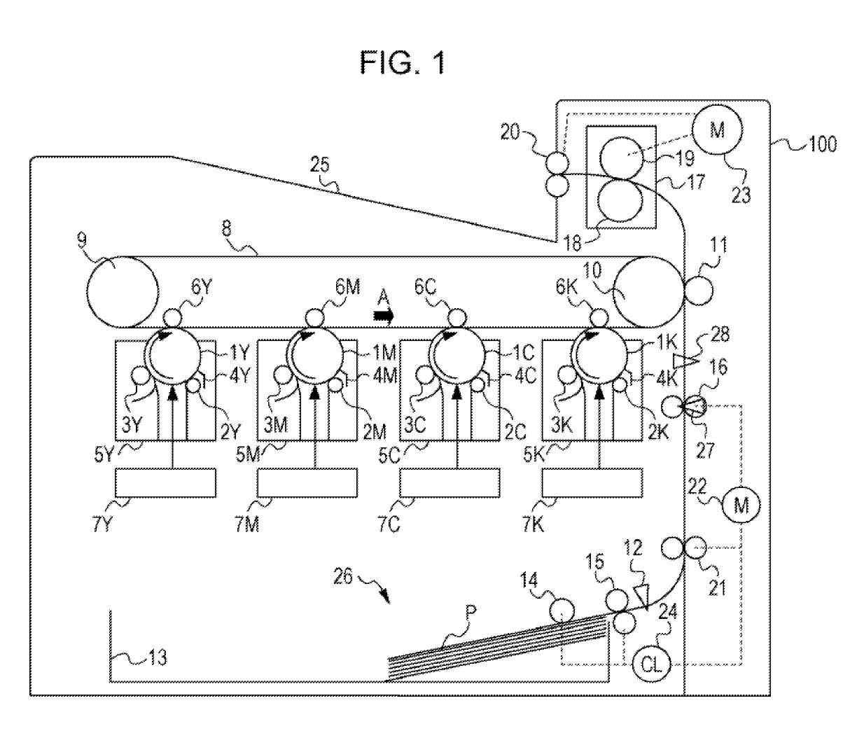

In the present embodiment, an electrophotographic laser beam printer 100 (hereinafter referred to as “printer 100”) will be described as the image forming apparatus. The printer 100 illustrated in FIG. 1 forms a color image on a sheet of paper P (a printing material).

### Image Forming Unit

The printer 100 includes process cartridges 5Y, 5M, 5C, and 5K which are detachable from the main body (also referred to as “casing”). The four process cartridges 5Y, 5M, 5C, and 5K have the same structure but differ in that they form an image with a yellow (Y), magenta (M), cyan (C), or black (K) toner. Thus, in FIG. 1, a member of a specific color represented by attaching one of signs indicating the colors (Y, M, C, and K) to a sign corresponding to the member. In the case where there is no need to specify a member of a specific color, the signs representing the colors (Y, M, C, and K) will be omitted hereinbelow.

The process cartridges 5 each include a photosensitive drum 1 serving as an image bearing member, a charging roller 2, a developing roller 3, a drum cleaning blade 4, and a waste-toner container. The photosensitive drums 1 are each charged to a predetermined negative potential by each charging roller 2 and are than exposed to light by each laser unit 7. The laser units 7 expose the photosensitive drums 1 to light based on image signals. This causes electrostatic latent images to be formed on the surfaces of the photosensitive drums 1. These electrostatic latent images are reversely developed by the developing rollers 3 with negative-polarity toners, so that Y, M, C, and K toner images are formed on the surfaces of the photosensitive drums 1.

An intermediate transfer belt unit includes an intermediate transfer belt 8, a driving roller 9, and a secondary-transfer facing roller 10. Primary transfer rollers 6 are disposed inside the intermediate transfer belt 8 so as to face the photosensitive drums 1. A transfer bias is applied to the primary transfer rollers 6 by bias applying units (not illustrated). The photosensitive drums 1 rotate in the direction of arrow in FIG. 1. The intermediate transfer belt 8 rotates in the direction of arrow A. By applying a positive transfer bias to the primary transfer rollers 6, the toner images formed on the photosensitive drums 1 are primarily transferred to the intermediate transfer belt 8 in sequence. Since the toner images of four colors are superposed and transferred, a color toner image is formed on the intermediate transfer belt 8.

### Feeding Conveying Unit

A feeding conveying unit 26 includes a sheet feed cassette 13 in which sheets P are held (placed), a sheet feeding roller 14 that feeds the sheets P from the sheet feed cassette 13, and conveying rollers 15 and 21 that convey the fed sheets P. The sheet feeding roller 14 and the conveying rollers 15 and 21 are rotated by a sheet feeding motor 22. The driving of the sheet feeding roller 14 and the conveying roller 15 is switched between connection and interruption by a sheet feeding clutch 24. By driving the sheet feeding motor 22 and transmitting the driving of the sheet feeding motor 22 to the sheet feeding roller 14 and the conveying roller 15 with the sheet feeding clutch 24 for a predetermined time, the uppermost sheet P in the sheet feed cassette 13 is conveyed downstream of the conveying path. The sheet P conveyed from the feeding conveying unit 26 is conveyed to a transfer nip (described later) by a registration roller 16 using the sheet feeding motor 22 as its driving source. A conveyance sensor 12, a registration sensor 27, which is a recording-material detecting unit, and a transfer loop sensor 28, which is a loop detecting unit, are sensors for detecting the sheet P, the details of which be described later.

### Transfer Unit

A secondary transfer roller 11 and the secondary-transfer facing roller 10 form a transfer nip. In the transfer nip, the color toner image formed on the intermediate transfer belt 8 is secondarily transferred to the sheet P conveyed by the registration roller 16. In the transfer from the intermediate transfer belt 8 to the sheet P, a positive transfer bias is applied to the secondary transfer roller 11.

### Fixing Unit

A pressure roller 19 that constitutes a fixing unit 17 is rotationally driven by a fixing motor 23 at a predetermined circumferential velocity. A fixing film 18 is rotationally driven at substantially the same circumferential velocity as the circumferential velocity of the pressure roller 19 under a predetermined pressure from the pressure roller 19 while sliding in close-contact with the surface of the pressure roller 19. The sheet P to which the toner image is transferred is heated and pressed by the fixing film 18 and the pressure roller 19, so that the toner image is fixed thereto. The sheet P to which the toner image is fixed is discharged to an output tray 25 by a discharge roller 20 that is rotationally driven by the fixing motor 23.

### Control Block Diagram of Image Forming Apparatus

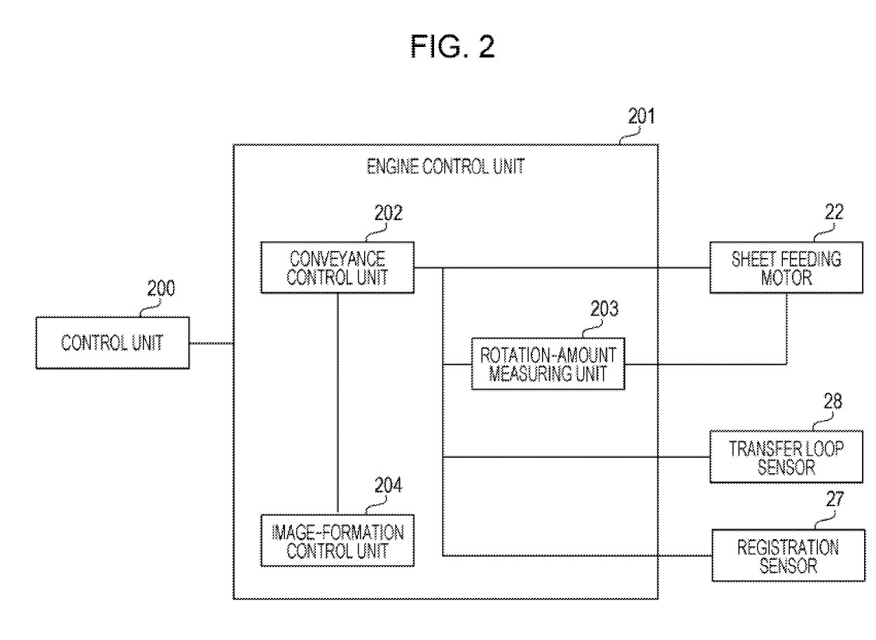

FIG. 2 is a control block diagram of the printer 100. An engine control unit 201 includes an application specific integrated circuit (ASIC)ca for controlling actuators, such as a motor and a high-voltage output unit, a read-only memory (ROM) that stores control programs, a random access memory (RAM) that stores data and so on, and a gate element.

The engine control unit 201 controls the overall operation of the printer 100. The engine control unit 201 includes as its function a conveyance control unit 202 that controls conveyance of sheets P based on information obtained from the registration sensor 27, the transfer loop sensor 28 and so on. The engine control unit 201 further includes a rotation-amount measuring unit 203 that measures the rotation amount of the sheet feeding motor 22. The engine control unit 201 further includes an image-formation control unit 204 that obtains image information from a control unit 200 and controls the operation of forming images on the sheet P performed by the process cartridge 5 and so on.

The control unit 200 includes a central processing unit (CPU) that controls the overall operation, a ROM that stores a control program, a RAM that stores data and so on, and a gate element. The control unit 200 is connected to an image scanning unit, a computer, and other units (not illustrated) and to the engine control unit 201 via communication lines. The control unit 200 generates information on the region of an image formed on the sheet P based on information from the image scanning, unit and the computer and transmits the information to the engine control unit 201.

Part or all of the functions of the CPU may be performed by the ASIC. On the contrary, part or all of the functions of the ASIC may be performed by the CPU. Part of the functions of the engine control unit 201 may be executed by another hardware corresponding to the control unit. The form of the hardware is not limited in implementing the above functions. Any of the CPU, the ASIC, and another hardware may be used or may share the processes in any way.

### Image Registration Control

The registration sensor 27 for detecting the leading end and the trailing end of the sheet P is provided at the position of the registration roller 16 to transfer the toner image to a correct position of the sheet P. The leading end of the sheet P is a downstream end in the conveying direction, and the trailing end of the sheet P is an upstream end in the conveying direction.

The conveyance control unit 202 controls the sheet feeding motor 22 based on the timing at which the leading end of the sheet P reaches the registration roller 16 (the timing when the leading end of the sheet P is detected by the registration sensor 27) and the timing at which image formation is started. In other words, the conveyance control unit 202 controls the sheet feeding motor 22 so that the sheet P reaches the transfer nip in accordance with the timing at which the toner image formed on the intermediate transfer belt 8 reaches the transfer nip. The conveying speed of the sheet P is changed by changing the rotational speed (the rotational speed per unit time) of the sheet feeding motor 22. A method for controlling the sheet feeding motor 22 is selected from the following two methods.

### Acceleration/Deceleration Control

The conveyance control unit 202 accelerates or decelerates the sheet feeding motor 22 to convey the sheet P a predetermined distance from the registration roller 16 to the transfer nip in the time remaining until the toner image formed on the intermediate transfer belt 8 reaches the transfer nip. In other words, the conveyance control unit 202 accelerates or decelerates the conveying speed of the sheet P. At that time, the conveyance control unit 202 does not stop the sheet feeding motor 22. When the leading end of the sheet P reaches the transfer nip, the conveyance control unit 202 returns the rotational speed of the sheet feeding motor 22 so that the sheet P and the intermediate transfer belt 8 run at the same circumferential speed.

### Temporary Stop Control

In the case where a long time remains until the toner image formed on the intermediate transfer belt 8 reaches the transfer nip, so that the sheet P reaches the transfer nip earlier than the toner image even if the sheet feeding motor 22 is decelerated at the maximum by the acceleration/deceleration control, the conveyance control unit 202 stops the sheet feeding motor 22 for a predetermined time. This allows the sheet P to wait at a predetermined position upstream from the transfer nip. The conveyance control unit 202 drives the sheet feeding motor 22 again in accordance with the timing at which the toner image reaches the transfer nip. As the acceleration/deceleration control, when the leading end of the sheet P reaches the transfer nip, the conveyance control unit 202 returns the rotational speed of the sheet feeding motor 22 so that the sheet P and the intermediate transfer belt 8 rotate at the same circumferential speed.

In both of the two control operations, the position of the sheet P needs to be correctly controlled by the registration roller 16 and the sheet feeding motor 22. For that purpose, the sheet feeding motor 22 of the present embodiment is a stepping motor capable of correctly controlling and measuring the axial rotation amount or includes an encoder or the like for detecting the axial rotation amount. The encoder is configured to output a pulse signal in response to the rotation of the sheet feeding motor 22.

The conveyance control unit 202 takes into account the distance the sheet P is conveyed by the registration roller 16 (conveying distance) obtained according to the diameter the speed-reduction ratio, and the rotation amount of the registration roller 16 in designing the apparatus, the time taken to slow up/down the sheet feeding motor 22, and the conveying distance. The conveyance control unit 202 further takes into account the time remaining until the toner image formed on the intermediate transfer belt 8 reaches the transfer nip. For the acceleration/deceleration control, the conveyance control unit 202 determines the rotational speed of the sheet feeding motor 22 and the timing at which the speed is to be changed (acceleration timing and deceleration timing) in view of the above. For the temporary stop control, the conveyance control unit 202 determines the time to stop the sheet feeding motor 22. The details of the acceleration/deceleration control and the temporary stop control will be omitted.

### Transfer Loop Control

The conveyance control unit 202 executes transfer loop control for forming a loop in the sheet P after the leading end of the sheet P reaches the transfer nip until the trailing end of the sheet P passes through the registration roller 16. The transfer loop control is control for changing the rotational speed of the sheet feeding motor 22 based on the detection result of the transfer loop sensor 28 that detects the loop amount of the sheet P. The transfer loop control optimizes the loop amount of the sheet P between the transfer nip and the registration roller 16.

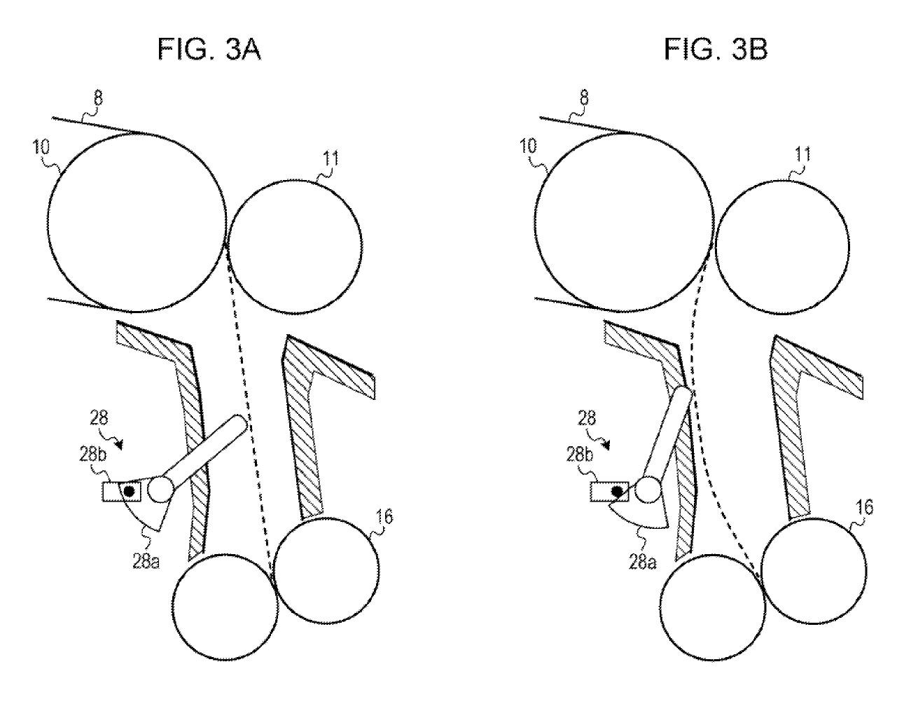

FIGS. 3A and 3B illustrate a state in which the transfer loop control is executed. The transfer loop sensor 28 is disposed between the registration roller 16 and the secondary transfer roller 11. The transfer loop sensor 28 includes a flag 28a, which is in contact with the sheet P, and a photo-interrupter 28b. The detection result of the transfer loop sensor 28 is indicated by binary values of HI/LO. When the flag 28a blocks the light from the photo-interruptor 28b, as illustrated in FIG. 3A, the detection result of the transfer loop sensor 28 is HI. The detection result HI indicates that the sheet P is stretched (the loop amount is less than a predetermined threshold). When the flag 28a does not block off the light from the photo-interruptor 28b, as illustrated in FIG. 3B, the detection result of the transfer loop sensor 28 is LO. The detection result LO indicates that the sheet P is slack (the loop amount is greater than the predetermined threshold).

While the detection result of the transfer loop sensor 28 is HI during the loop control, the conveyance control unit 202 drives the registration roller 16 at a higher speed than the secondary transfer roller 11 to increase the loop amount of the sheet P. In contrast, while the detection result of the transfer loop sensor 28 is LO, the conveyance control unit 202 drives the registration roller 16 at a lower speed than the secondary transfer roller 11 to decrease the loop amount of the sheet P.

When the diameter (outside diameter) of the registration roller 16 is decreased due to aging wear, the sheet P conveying speed of the registration roller 16, which is obtained when the sheet feeding motor 22 is driven at a predetermined rotational speed, decreases. In other words, as the aging wear advances, a sufficient conveying speed for maintaining a desired loop amount cannot be obtained, increasing the time during which the output of the transfer loop sensor 28 detected during the loop control is HI. As a result, the rotation amount of the sheet feeding motor 22 necessary for conveying a sheet P of the same length increases. The aging wear means that the surface of the registration roller 16 is worn by repeated use over a long period of time.

### Estimating Diameter of Registration Roller 16

In the present embodiment, the rotation-amount measuring unit 203 measures the rotation amount of the sheet feeding motor 22 during transfer loop control for one sheet P1, and the conveyance control unit 202 calculates the distance the sheet P is conveyed by the registration roller 16 from the measured rotation amount. Then, the conveyance control unit 202 estimates the present diameter of the registration roller 16 from the ratio of the actual conveying distance to a design distance over which the sheet P is conveyed under transfer loop control and the ideal diameter of the registration roller 16 that is not worn.

A specific example of obtaining the diameter of the registration roller 16 will be described. In the present embodiment, the diameter is calculated using the parameters listed in Table 1 by way of example. In the case where the encoder pulse count EP1p of the sheet feeding motor 22 measured during transfer loop control is the value in Table 2, the estimated diameter Ract of the registration roller 16 is given by Eq. 1. The period of transfer loop control is a period during which one sheet P is conveyed by both of the registration roller 16 and the secondary transfer roller 11.

TABLE 1

| Item | Sign | Design value | |
|---|---|---|---|
| Ideal diameter of registration roller | Rref | 15.0 | [mm] |
| 16 | | | |
| Encoder pulse count for one rotation | Epmtr | 360 | [pulse] |
| of shaft of sheet feeding motor 22 | | | |
| Deceleration ratio of shaft of sheet | Ratio | 0.4 | |
| feeding motor 22 to registration | | | |
| roller 16 | | | |
| Ideal conveying speed of registration | SPDref | 200.0 | [mm/sec] |
| roller 16 | | | |
| Rotational speed of registration | SPDreg | =SPDref ÷ | |
| roller 16 for obtaining ideal | | (Rref × π) = 4.24 [rps] | |
| conveying speed of registration | | | |
| roller 16 | | | |
| Rotational speed of sheet feeding | SPDmtr | =SPDreg ÷ | |
| motor 22 for obtaining ideal | | Ratio = 10.61 [rps] | |
| conveying speed of registration | | | |
| roller 16 | | | |
| Conveying distance of registration | Llep | =SPDref ÷ (EPmtr × | |
| roller 16 for one encoder pulse | | SPDmtr = 0.05236 [mm] | |
| of sheet feeding motor 22 | | | |
| Length of sheet P in conveying | Lp | 297.0 | [mm] |
| direction | | | |
| Conveying distance from registration | Lrt | 50.0 | [mm] |
| roller 16 to secondary transfer | | | |
| roller 11 | | | |

| | | |
|---|---|---|
| Ideal conveying distance of sheet P | Lplp | =Lp − Lrt = |
| at transfer loop control | | 247.0 [mm] |

TABLE 2

| Item | Sign | Measured value |
|---|---|---|
| Encoder pulse count of sheet feeding motor 22 | EPlp | 4,654 [pulse] |
| measured during transfer loop control | | |

$$Estimated diameter Ract = \frac{\begin{matrix}Pulse count EPlp \times \\ Conveying distance per pulse Llep\end{matrix}}{Conveying distance under loop control Lplp} \times Ideal diameter Rref \\ Estimated diameter Ract = 4654 \times \frac{0.05236}{247.0} \times 15.0 \\ Estimated diameter Ract = 14.8 [ mm ] \qquad [ Eq . 1 ]$$

### Collecting Speed by Transfer Loop Control

In the transfer loop control, the speed at which the sheet P is conveyed by the registration roller 16 is accelerated or decelerated by accelerating or decelerating the rotational speed of the sheet feeding motor 22 based on the detection result of the transfer loop sensor 28, as described above. Thus, an appropriate loop amount of the sheet P is maintained between the registration roller 16 and the secondary transfer roller 11.

In the case of control in which the acceleration is +1% for HI and the deceleration is −1% for LO, if the diameter of the registration roller 16 is worn out by 1% of the ideal diameter, the actual conveying speed is +0% for acceleration, and −2% for deceleration. In this state, a desired loop amount cannot be achieved and maintained. Thus, the conveyance control unit 202 corrects the rotational speed (for acceleration/deceleration) of the sheet feeding motor 22 at the transfer loop control based on Eq. 2 and Eq. 3 using the estimated diameter Ract of the registration roller 16.

$$\begin{matrix}Rotational speed ( for acceleration ) = Rotation speed before correction ( for acceleration ) \times \frac{Ideal diameter Rref}{Estimated diameter Ract} & [ Eq . 2 ] \\ Rotation speed ( for deceleration ) = Rotation speed before correction ( for deceleration ) \times \frac{Ideal diameter Rref}{Estimated diameter Ract} & [ Eq . 3 ]\end{matrix}$$

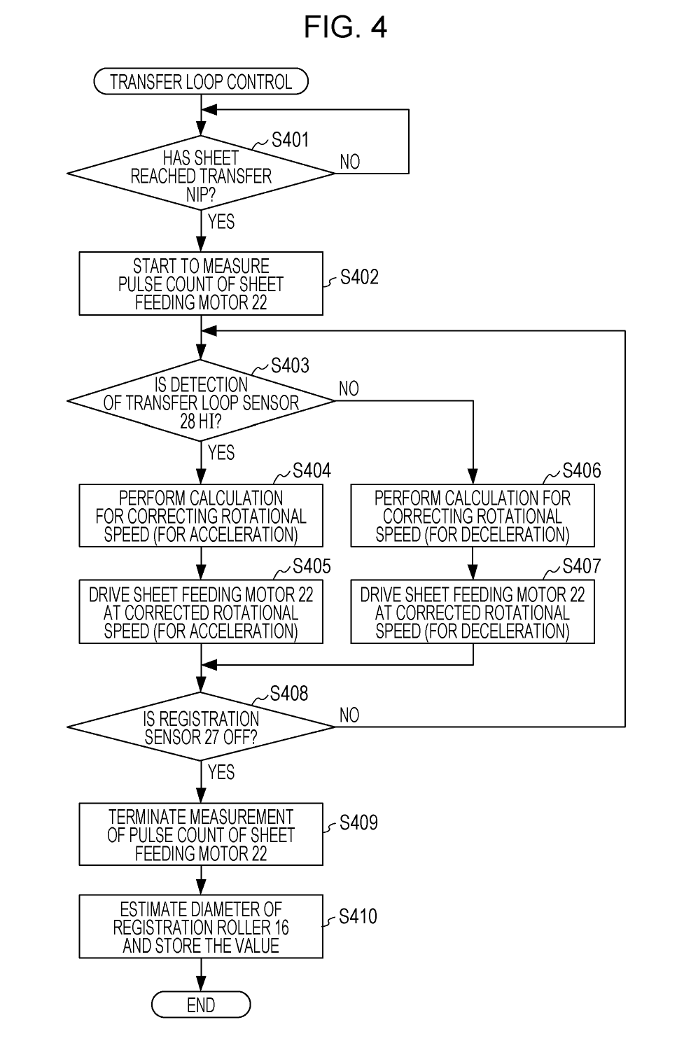

FIG. 4 is a flowchart for the transfer loop control of the present embodiment. This flowchart is stored in the ROM of the engine control unit 201 and is executed by the CPU. This flowchart is executed after the printer 100 conveys at least one sheet P and obtains the estimated diameter Ract of the registration roller 16.

When the leading end of the sheet P conveyed by the registration roller 16 reaches the transfer nip (secondary transfer roller 11), the rotation-amount measuring unit 203 starts to measure the encoder pulse count, which is the rotation amount of the sheet feeding motor 22 (S401 and S402). The conveyance control unit 202 monitors the detection result of the transfer loop sensor 28 until the trailing end of the sheet P passes by the registration sensor 27 (S408) (S403).

The conveyance control unit 202 changes the rotational speed of the sheet feeding motor 22 according to the detection result (HI or LO) of the transfer loop sensor 28. If the transfer loop sensor 28 indicates HI, the conveyance control unit 202 obtains the rotational speed of the sheet feeding motor 22 from Eq. 2 based on the estimated diameter Ract of the registration roller 16 (S404). The conveyance control unit 202 drives the sheet feeding motor 22 so that the sheet feeding motor 22 rotates at the obtained rotational speed. In contrast, if the transfer loop sensor 28 indicates LO, the conveyance control unit 202 obtains the rotational speed of the sheet feeding motor 22 from Eq. 3 based on the estimated diameter Ract of the registration roller 16 (S406). The conveyance control unit 202 drives the sheet feeding motor 22 so that the sheet feeding motor 22 rotates at the obtained rotational speed (S407).

When the conveyance control unit 202 detects that the trailing end of the sheet P passes by the registration sensor 27, the conveyance control unit 202 terminates the measurement of the encoder pulse count, which is the rotation amount of the sheet feeding motor 22 (S409). The conveyance control unit 202 obtains the estimated diameter Ract of the registration roller 16 from Eq. 1 using the measured encoder pulse count as a parameter and stores the estimated diameter Ract in a non-volatile memory or the like (S410). Thus, the transfer loop control for one sheet P is completed, and the conveyance control unit 202 prepares for transfer loop control for the following sheet P.

### Collecting Speed in Image Registration Control

When the diameter of the registration roller 16 changes, the timing at which the sheet P is brought to the transfer nip (secondary transfer roller 11) is shifted by the acceleration/deceleration control or the temporary stop control described above. In particular, if the diameter of the registration roller 16 is decreased due to aging wear, the sheet P reaches the transfer nip later than the toner image. This causes the position at which the toner image is transferred to the sheet P to be shifted toward the leading end in the direction in which the sheet P is conveyed.

The present embodiment uses the estimated diameter Ract of the registration roller 16 to correct the misregistration of the image caused by the change in the diameter of the registration roller 16. The conveyance control unit 202 corrects the time Trem remaining from the timing at which the leading end of the sheet P reaches the registration roller 16 (the timing at which the leading end of the sheet P is detected by the registration sensor 27) until the toner image reaches the transfer nip by using the basis of Eq. 4 to Eq. 7. The corrected remaining time is used to determine various parameters for image registration control.

$$\begin{matrix}Ideal conveying time Tref = \frac{Conveying distance Lrt}{\begin{matrix}Ideal conveying speed of \\ registration roller 16 SPDref\end{matrix}} & [ Eq . 4 ] \\ Estimated conveying time Tact = Tref \times \frac{Ideal diameter Rref}{Estimated diameter Ract} & [ Eq . 5 ]\end{matrix}$$

Correction time Tdif=Estimated conveying time Tact−ideal conveying time Tref [Eq. 6]

Corrected remaining time=remaining time Trem−Tdif [Eq. 7]

The time for conveying the sheet P a predetermined distance using the worn registration roller 16 when the sheet feeding motor 22 is driven at a predetermined rotational speed can be calculated from the ratio of the estimated diameter to the ideal diameter of the registration roller 16. The difference between the time at which the toner image reaches the transfer nip and the time at which the sheet P conveyed by the registration roller 16 having the estimated diameter Ract reaches the transfer nip is subtracted from the remaining time Trem in advance. This allows correcting the time the sheet P is delayed with respect to the toner image at the position of the transfer nip.

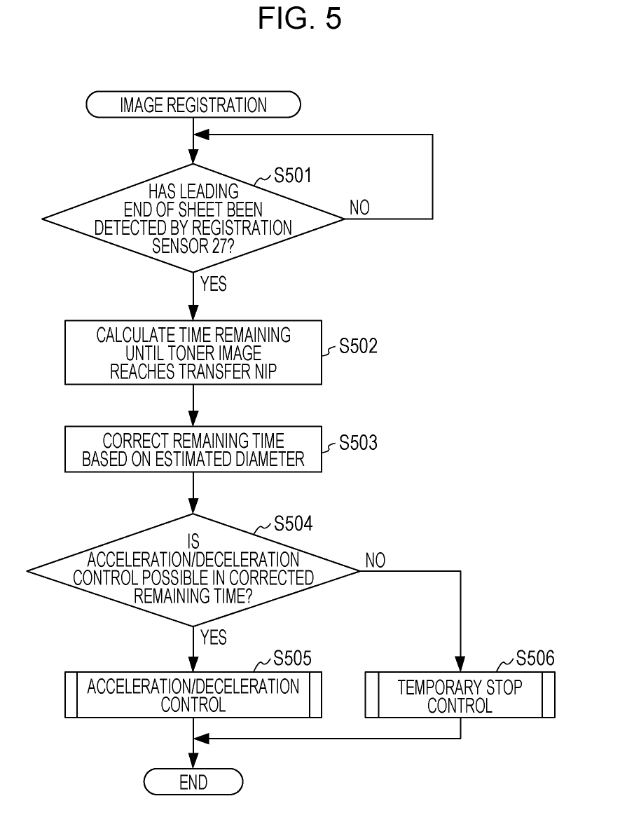

FIG. 5 illustrates a flowchart for the image registration control of the present embodiment. This flowchart is stored in the ROM of the engine control unit 201 and is executed by the CPU. This flowchart is executed after at least one sheet P is conveyed in the printer 100, and the estimated diameter Ract of the registration roller 16 is determined.

If the registration sensor 27 detects the leading end of the sheet P (S501), the conveyance control unit 202 calculates the time Trem remaining until the toner image formed on the intermediate transfer belt 8 reaches the transfer nip (S502). Furthermore, the conveyance control unit 202 calculates the time lag between the times at which the toner image and the sheet P reach the transfer nip from the estimated diameter Ract and corrects the time Trem remaining until the toner image reaches the transfer nip (S503). The conveyance control unit 202 selects the acceleration/deceleration control or the temporary stop control based on the corrected remaining time and the response performance of the sheet feeding motor 22 (S504). In other words, the conveyance control unit 202 selects the temporary stop control when the sheet P reaches the transfer nip earlier than the toner image even if the conveying speed of the sheet P is reduced at the maximum (S506). Otherwise, the conveyance control unit 202 selects the acceleration/deceleration control (S505).

If the conveyance control unit 202 selects the acceleration/deceleration control (S505), the conveyance control unit 202 obtains the rotational speed of the sheet feeding motor 22 after being accelerated or decelerated and the taming at which the rotation speed is to be changed (acceleration timing or deceleration timing) based on the corrected remaining time. If the conveyance control unit 202 selects the temporary stop control (S506), the conveyance control unit 202 obtains the time to stop the sheet feeding motor 22 based on the corrected remaining time. Thus, the image registration control for one sheet P is completed, and the conveyance control unit 202 prepares for image registration control for the following sheet P. Detecting expansion due to change in estimated diameter of registration roller 16 and correcting estimated diameter

The diameter of the registration roller 16 can change due to thermal expansion or contraction as well as aging wear. For example, in continuous two-sided printing, when a sheet P heated by the fixing unit 17 at image formation on the first surface passes through the registration roller 16 at image formation on the second surface, the registration roller 16 is heated. This causes the registration roller 16 to gradually increase in temperature and expand, thereby increasing the estimated diameter.

In contrast, in continuous one-sided printing, when a sheet P that is lower in temperature than the registration roller 16, which is expanded due to temperature rise, passes through the registration roller 16, the sheet P draws heat from the registration roller 16. This causes the registration roller 16 to be gradually cooled and contracted, thereby decreasing the estimated diameter. The registration roller 16 that is expanded due to temperature rise is cooled also with the passage of time and is contracted.

The change in the diameter of the registration roller 16 due to aging wear is a gradual decrease from the beginning of the life of the printer 100 to the end of the life, while the change in the diameter of the registration roller 16 due to expansion or contraction is a rapid increase or decrease according to a change in the temperature of the registration roller 16 in image formation.

When the estimated diameter calculated by the above-described method changes more than the assumed change due to aging wear, it can be determined that the registration roller 16 expands or contracts. Also when the registration roller 16 expands or contracts during a continuous printing operation, the estimated diameter of the registration roller 16 calculated at the passage of the preceding sheet P is a value closest to the current diameter of the registration roller 16. For that reason, the conveyance control unit 202 corrects the speeds of the image registration control and the transfer loop control on the sheet P based on the estimated diameter immediately before.

However, for example, when the registration roller 16 is cooled and contracted after a long time elapsed from the time when the estimated diameter of the heated and expanded registration roller 16 is stored, the difference between the stored estimated diameter and the actual diameter increases. In this case, the sheet P cannot be conveyed at the desired speed even if the speeds of the image registration control and the transfer loop control are corrected based on the stored estimated diameter of the expanded registration roller 16.

Therefore, the conveyance control unit 202 detects the expansion or contraction of the diameter of the registration roller 16 during the continuous printing operation and corrects the stored estimated diameter of the registration roller 16 at the start of the continuous printing operation according to the history of expansion detection and the time elapsed from the previous printing operation. For example, the conveyance control unit 202 measures the time from a state in which the registration roller 16 expands to the time when the printing operation stops and the diameter returns to the original diameter. If the time is 100 minutes, the percentage of contraction per minute is 1%. The conveyance control unit 202 determines the estimated diameter of the registration roller 16 by multiplying the difference between the estimated diameter of the registration roller 16 immediately before expansion is detected and the estimated diameter of the registration roller 16 when expansion is detected by the percentage of contraction (100% at the maximum) obtained from the measured elapsed time and subtracting the product from the estimated diameter of the registration roller 16 when expansion is detected.

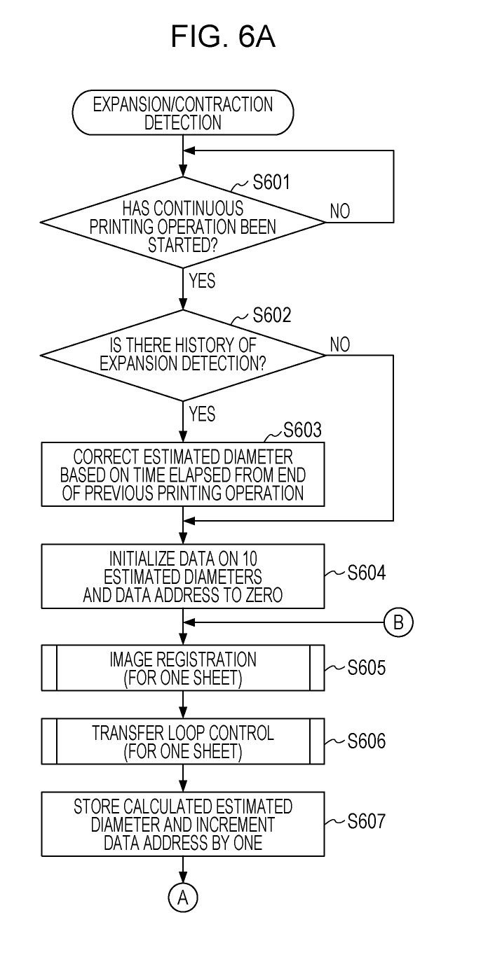

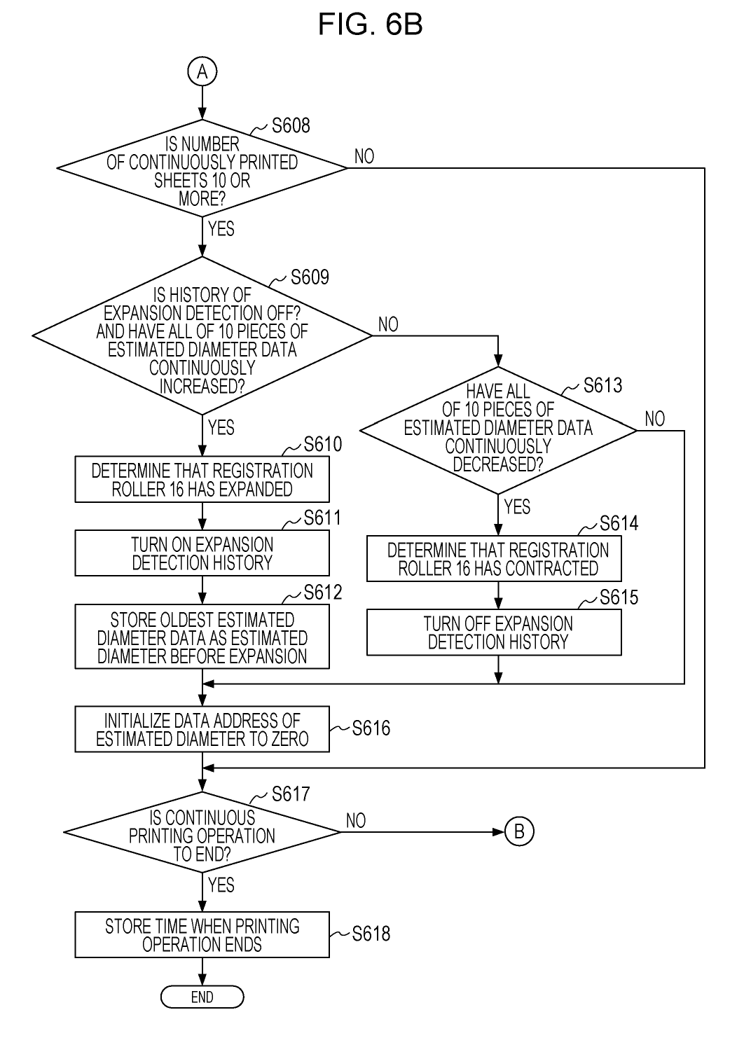

FIGS. 6A and 6B illustrate a flowchart for the expansion or contraction detecting process of the present embodiment. This flowchart is stored in the ROM of the engine control unit 201 and is executed by the CPU. This flowchart is started when an instruction to perform continuous printing (an instruction to perform a print job) is given.

When a continuous printing operation is started (S601), the conveyance control unit 202 determines whether there is a history of defection of expansion of the registration roller 16 before the end of the previous printing operation (S602). If there is a history of detection of expansion, the conveyance control unit 202 calculates the current estimated diameter of the registration roller 16 based on the time elapsed from the end of the previous printing operation and the percentage of contraction per unit time (S603). More specifically, the conveyance control unit 202 multiplies the difference between the estimated diameter of the registration roller 16 immediately before expansion is detected and the last stored estimated diameter of the registration roller 16 by the percentage of contraction obtained from the measured elapsed time. The conveyance control unit 202 then subtracts the obtained estimated diameter of the registration roller 16 from the last stored estimated diameter to calculate the current estimated diameter of the registration roller 16. The details of the estimated diameter of the registration roller 16 immediately before expansion is detected will be described later.

Next, the conveyance control unit 202 initializes the memory to detect expansion or contraction (S604). The memory is used to store the estimated diameter of the registration roller 16. The conveyance control unit 202 performs the transfer loop control illustrated in the flowchart of FIG. 4 and the image registration control illustrated in the flowchart of FIG. 5 for one sheet P. Upon completion of the transfer loop control, the conveyance control unit 202 obtains the estimated diameter of the registration roller 16, stores the estimated diameter in a memory region indicated by its data address, and adds 1 to the data address (S607). The memory is capable of storing 10 estimated diameters of the registration roller 16. The conveyance control unit 202 repeats the above process until the number of continuously printed sheets reaches 10 or the continuous printing operation ends (S608 or S617).

If the number of continuously printed sheets P is 10 or more, the memory stores the last 10 pieces of estimated diameter data. Therefore, the conveyance control unit 202 determines whether the registration roller 16 expands or contracts from the expansion detection history and the 10 pieces of estimated diameter data. If there is no expansion detection history and the 10 pieces of estimated diameter data has increased in chronological order (S609), the conveyance control unit 202 determines that the registration roller 16 has expanded and turns on the expansion detection history (S610 and S611). The conveyance control unit 202 stores the oldest data of the 10 pieces of estimated diameter data in another memory region as the estimated diameter of the registration roller 16 immediately before expansion is detected (S612).

If the determination result in S609 is NO, the conveyance control unit 202 determines whether the 10 pieces of estimated diameter data has decreased in chronological order (S613). If the determination result in S613 is YES, the conveyance control unit 202 determines that the registration roller 16 has contracted and turns off the expansion detection history (S614 and S615). If the determination result in S613 is NO, the conveyance control unit 202 determines that the registration roller 16 has neither expanded nor contracted. In other words, the 10 pieces of data are within the range of variations in detection or the like. After execution of the determination of expansion or contraction for 10 pieces of estimated diameter data, the conveyance control unit 202 clears the stored data address to 0 (S616). If the continuous printing operation is to be continued, the process returns to S605. If the continuous printing operation is to be terminated, the time at which the printing operation ends is stored, and the continuous printing operation ends (S617 and S618).

Thus, the present embodiment can stabilize the transfer loop control and the image registration control with no increase in cost without additional special hardware by estimating the speed at which the sheet P is conveyed by the registration roller 16.

In particular, the use of the rotation amount of the sheet feeding motor 22 during the transfer loop control allows estimating the actual speed of the sheet P conveyed by the registration roller 16. This allows setting the rotational speed of the sheet feeding motor 22 according to the stats of the registration roller 16 according to the actual use situation, such as the operating environment of the printer 100 and the type (surface property, thickness, and basis weight) of the sheet P passed therethrough. This allows executing the transfer loop control and the image registration control with higher accuracy than before.

Since the corrective calculation and determination of expansion or contraction performed in the flowcharts of FIGS. 4, 5, and 6 need the estimated diameter of the registration roller 16 in advance, the flowcharts are executed after at least one sheet P is conveyed. This is given merely for illustrative purposes and is not intended to limit the present disclosure. For example, the ideal diameter of the registration roller 16 may be stored in a storage region for the estimated diameter of the registration roller 16 when the registration roller 16 is new, such as at the factory shipment of the printer 100.

The various parameters and how they are obtained described in the present embodiment are given for mere illustrative purposes and are not intended to limit the present disclosure. For example, the number of times to store and determine continuous changes to detect the expansion or contraction of the registration roller 16 is not limited to 10 and may be changed according to how the registration roller 16 expands or contracts, measured in developing the product, and the memory capacity of the engine control unit 201.

In the present embodiment, the control for detecting expansion or contraction illustrated in FIGS. 6A and 6B is not absolutely necessary. The control for detecting expansion or contraction may not be performed but the transfer loop control illustrated in FIG. 4 and the image registration control illustrated in FIG. 5 may be executed based on the estimated diameter of the registration roller 16 obtained immediately before.

The estimated diameter of the registration roller 16 to be stored in the non-volatile memory or the like may be corrected according to the size or type of the sheet P passed therethrough. The estimated diameter of the registration roller 16 may not be updated every transfer loop control for one sheet P, but may be updated based on the average value of the detection results of a plurality of sheets P.

### Second Embodiment

In the present embodiment, a method for detecting that the aging wear of the registration roller 16 has advanced, so that the performance of the printer 100 cannot be fulfilled, that is, the life has expired, and a method for detecting that the registration roller 16 has been replaced will be described. Since main points are the same as in the first embodiment, only differences from the first embodiment will be described.

### Detecting Life of Registration Roller 16 Due to Change in Estimated Diameter

The diameter of the registration roller 16 gradually decreases due to aging wear from the beginning of the life of the printer 100 to the end of the life. In other words, when the estimated diameter becomes less than the diameter at the end of estimated design life, it can be determined that the life of the registration roller 16 has expired.

### Detecting Replacement of Registration Roller 16 Due to Change in Estimated Diameter

When the life of the registration roller 16 ends, the registration roller 16 is replaced with new one by the user of the printer 100 or a service person. The diameter of the registration roller 16 at the beginning of life and the diameter at the end of life have a large difference. Therefore, when the registration roller 16 is replaced with new one, with the estimated diameter calculated at the end of the life stored, the estimated diameter calculated from the result of next transfer loop control is significantly greater than the stored estimated diameter. In other words, when the estimated diameter calculated at the start of the printing operation has greatly increased from the stored estimated diameter, it can be determined that the registration roller 16 has been replaced with new one.

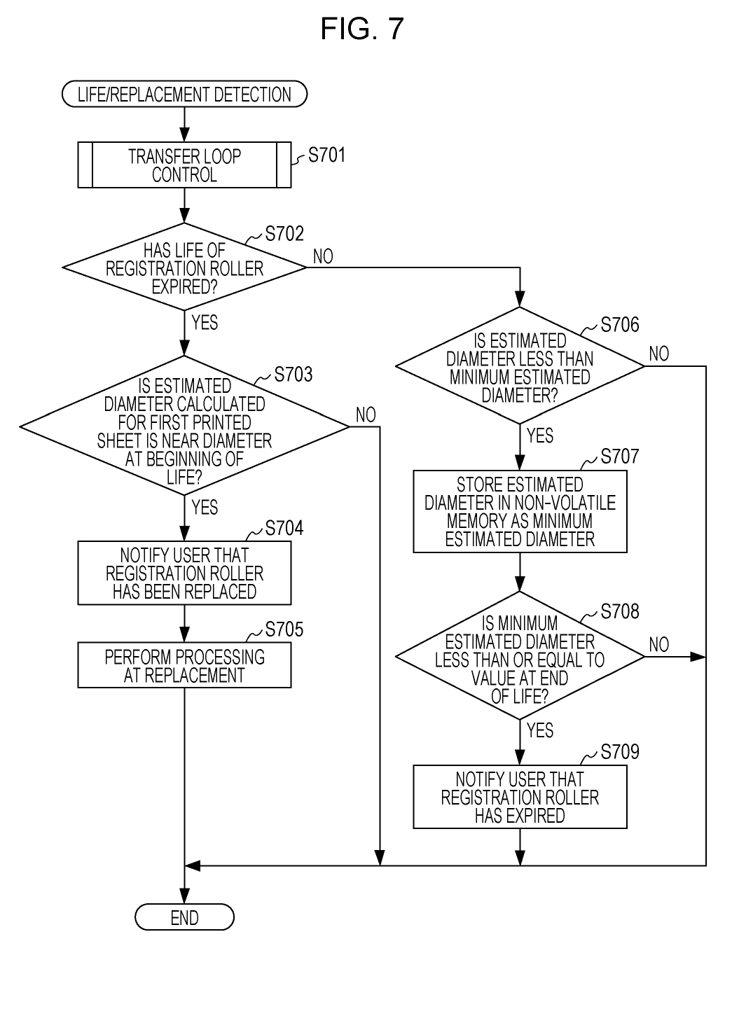

The present embodiment executes the flowchart in FIG. 7 every time the estimated diameter of the registration roller 16 is calculated to thereby detect whether the life of the registration roller 16 has expired and whether the registration roller 16 has been replaced with new one from a change in the estimated diameter of the registration roller 16. This embodiment notifies the user of the expiration of life and the replacement of the registration roller 16 and initializes the non-volatile memory that stores life information related to the replacement of the registration roller 16. The flowchart in FIG. 7 is stored in the ROM of the engine control unit 201 and is executed by the CPU.

First, the conveyance control unit 202 causes the sheet P to be conveyed, executes the transfer loop control, and calculates the estimated diameter of the registration roller 16 (S701). Next, if the conveyance control unit 202 has given a notification that the life of the registration roller 16 has expired (S702), then in S703 and the subsequent steps, the conveyance control unit 202 performs the process for detecting whether the registration roller 16 has been replaced. If the life has not expired, then in S706 and the subsequent steps, the conveyance control unit 202 performs the process of detecting whether the life of the registration roller 16 has expired.

If the life of the registration roller 16 has expired and the estimated diameter of the registration roller 16 calculated for the first sheet P of the printing operation falls within the range of, for example, ±1% of the ideal diameter, the conveyance control unit 202 determines that the registration roller 16 has been replaced with new one (S703). When the conveyance control unit 202 determines that the registration roller 16 has been replaced with new one, the conveyance control unit 202 notifies the user of the replacement via an operation panel (not illustrated) disposed on the printer 100 or the display of a personal computer (PC) connected over a network (S704). Furthermore, the conveyance control unit 202 performs a process when the registration roller 16 is replaced, for example, initialization of life-related data stored in the non-volatile memory (S705). The condition for detecting replacement of the registration roller 16 is that the detection is performed on the first sheet in the printing operation. This is because, in order to replace the registration roller 16, it is necessary to stop the printing operation of the printer 100. In other words, it is always the first sheet P after the start of the printing operation that the estimated diameter greatly changes due to replacement of the registration roller 16.

If the conveyance control unit 202 has not given an alarm indicating that the life of the registration roller 16 has expired, then the conveyance control unit 202 compares the estimated diameter of the registration roller 16 calculated this time with the minimum value of the calculated estimated diameters of the registration roller 16 (a minimum estimated diameter) (S706). If the calculated estimated diameter of the registration roller 16 falls below the minimum value, the conveyance control unit 202 updates the minimum estimated diameter in the non-volatile memory (S707). If the updated minimum estimated diameter is the diameter of the registration roller 16 at the end of life, that is, less than or equal to 95% of the ideal diameter of the registration roller 16, the conveyance control unit 202 determines that the life of the registration roller 16 has expired (S708). When the conveyance control unit 202 determines that the life of the registration roller 16 has expired, the conveyance control unit 202 notifies the user of the expiration via the operation panel (not illustrated) disposed on the printer 100, the display of a PC connected via a network, or the like (S709). One reason why the minimum estimated diameter is used to determine whether the life has expired is because determination of the end of life using an estimated diameter measured in the expanded state cannot fulfill the performance in the contracted state. Another reason is to prevent generation of a period during which the end of life cannot be notified because of the influence of expansion of the registration roller 16.

Thus, the present embodiment allows detecting that the registration roller 16 has expired or has been replaced without additional special hardware.

The various parameters and methods for obtaining the parameters described in the present embodiment are provided merely for illustrative purposes and are not intended to limit the present disclosure. For example, the percentage 95% of the ideal diameter, which is given as the threshold of the diameter for use in determination of the expiration of the life of the registration roller 16, and the range ±1%, which is given as the ideal diameter for use in determination of replacement with new one, are provided merely for illustrative purposes and are not intended to limit the present disclosure. The minimum estimated diameter for use in determining expiration of the life may be an average value of two or more data groups close to the minimum value.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2017-136749 filed Jul. 13, 2017, which is hereby incorporated by reference herein in its entirety.

What is claimed is:

1. An image forming apparatus comprising:
a conveying unit configured to convey a printing material;
a transfer unit configured to transfer an image formed on an image bearing member to the printing material conveyed by the conveying unit;
a loop detecting unit configured to detect an amount of a loop formed in the printing material between the conveying unit and the transfer unit;
a driving source configured to drive the conveying unit;
a control unit configured to change a rotational speed of the driving source based on the detection result of the loop detecting unit; and
a measuring unit configured to measure a rotation amount of the driving source during a period in which a first printing material is conveyed by both of the conveying unit and the transfer unit,
wherein the control unit controls the rotational speed of the driving source based on the rotation amount of the driving source measured by the measuring unit so that a leading end of a second printing material reaches the transfer unit in accordance with the image formed on the image hearing member.

2. The image forming apparatus according to claim 1, further comprising a recording-material detecting unit disposed upstream from the transfer unit in a direction in which the printing material is conveyed,
wherein the recording-material detecting unit is configured to detect a printing material conveyed by the conveying unit,
wherein the control unit switches between first control and second control based on a timing at which the second printing material is detected by the recording-material detecting unit and the rotation amount of the driving source measured by the measuring unit,
wherein the first control is configured to cause the conveying unit to convey the second printing material to the transfer unit by accelerating or decelerating the conveying unit conveying speed without stopping the second printing material, and
wherein the second control is configured to cause the conveying unit to temporarily stop the second printing material and again convey the printing material to the transfer unit.

3. The image forming apparatus according to claim 2, wherein, in a case where the control unit executes the first control, the control unit obtains a speed of the second printing material after the conveying speed is accelerated or decelerated and a timing at which the conveying speed is accelerated or decelerated based on the timing at which the second printing material is detected by the recording-material detecting unit and the rotation amount of the driving source measured by the measuring unit.

4. The image forming apparatus according to claim 2, wherein, in a case where the control unit executes the second control, the control unit determines a period of time during which the second printing material is to be temporarily stopped based on the timing at which the second printing material is detected by the recording-material detecting unit and the rotation amount of the driving source measured by the measuring unit.

5. The image forming apparatus according to claim 1,
wherein the control unit obtains a change in outside diameter of the conveying unit according to the rotation amount of the driving source measured by the measuring unit, and
wherein, in a case where the outside diameter of the conveying unit increases continuously predetermined times, the control unit controls the rotational speed of the driving source based on a time elapsed after the conveying unit last conveys a printing material.

6. The image forming apparatus according to claim 1,
wherein, during a period in which both of the conveying unit and the transfer unit are conveying the first printing material and in a case where the control unit determines that a loop amount of the first printing material detected by the loop detecting unit is greater than a predetermined threshold, the control unit changes the rotational speed of the driving source to increase a speed at which the first printing material is conveyed by the conveying unit, and
wherein, during a period in which both of the conveying unit and the transfer unit are conveying the first printing material and in a case where the control unit determines that the loop amount of the first printing material is less than the predetermined threshold, the control unit changes the rotational speed of the driving source to decrease the speed at which the first printing material is conveyed by the conveying unit.

7. The image forming apparatus according to claim 1, wherein the loop detecting unit is disposed between the conveying unit and the transfer unit and includes a flag in contact with the printing material, and a photo-interruptor configured to output different signals according to a position of the flag.

8. The image forming apparatus according to claim 1,
wherein the measuring unit includes an encoder that outputs a pulse signal as the driving source rotates, and
wherein the measuring unit is configured to measure the rotation amount of the driving source according to a pulse count output from the encoder.

9. An image forming apparatus comprising:
a conveying unit configured to convey a printing material;
a transfer unit configured to transfer an image formed on an image bearing member to the printing material conveyed by the conveying unit;
a loop detecting unit configured to detect an amount of a loop formed in the printing material between the conveying unit and the transfer unit;
a driving source configured to drive the conveying unit;
a control unit configured to change a rotational speed of the driving source based on the detection result of the loop detecting unit; and
a measuring unit configured to measure a rotation amount of the driving source during a period in which a first printing material is conveyed by both of the conveying unit and the transfer unit,
wherein the control unit obtains a change in outside diameter of the conveying unit according to the rotation amount of the driving source measured by the measuring unit.

10. The image forming apparatus according to claim 9, wherein the control unit determines whether the conveying unit is replaced with a new member according to the change in the outside diameter of the conveying unit.

11. The image forming apparatus according to claim 9, wherein the control unit determines whether the conveying unit has expired in life according to the change in the outside diameter of the conveying unit.

12. The image forming apparatus according to claim 9,
wherein, during a period in which both of the conveying unit and the transfer unit are conveying the first printing material and in a case where the control unit determines that a loop amount of the first printing material detected by the loop detecting unit is greater than a predetermined threshold, the control unit changes the rotational speed of the driving source to increase a speed at which the first printing material is conveyed by the conveying unit, and
wherein, during a period in which both of the conveying unit and the transfer unit are conveying the first printing material and in a case where the control unit determines that the loop amount of the first printing material is less than the predetermined threshold, the control unit changes the rotational speed of the driving source to decrease the speed at which the first printing material is conveyed by the conveying unit.

13. The image forming apparatus according to claim 9, wherein the loop detecting unit is disposed between the conveying unit and the transfer unit and includes a flag in contact with the printing material and a photo-interrupter configured to output different signals according to a position of the flag.

14. The image forming apparatus according to claim 9,
wherein the measuring unit includes an encoder that outputs a pulse signal as the driving source rotates, and
wherein the measuring unit is configured to measure the rotation amount of the driving source according to a pulse count output from the encoder.
